(19) United States
(12) Patent Application Publication
(10) Pub. No.: US 2018/0361311 A1
(43) Pub. Date: Dec. 20, 2018

(54) MEMBRANE-BASED SYSTEM FOR GENERATING HIGH-PURITY NITROGEN

(71) Applicant: Generon IGS, Inc., Houston, TX (US)

(72) Inventors: John Font, Montgomery, TX (US); Ky Doucet, Missouri City, TX (US); Marc Straub, Brentwood, CA (US); John A. Jensvold, Benicia, CA (US)

(21) Appl. No.: 15/781,435

(22) PCT Filed: Dec. 7, 2016
(86) PCT No.: PCT/US16/65241

§ 371 Date: Jun. 4, 2018

Related U.S. Application Data
(60) Provisional application No. 62/265,007, filed on Dec. 9, 2015.

(51) Int. Cl. B01D 53/22; C01B 21/04; E21B 43/16

(52) U.S. Cl. CPC B01D 53/226; E21B 43/168; C01B 21/0438

(57) ABSTRACT

A non-cryogenic system for producing high-purity nitrogen is connected to a coiled-tubing unit. The nitrogen is produced by passing compressed ambient air through two polymeric membrane modules connected in series. The output of the second module is a stream of high-purity nitrogen, which is conveyed into a coiled tube. The nitrogen can be used for inerting the interior of the tube, or the coiled tube can be inserted into an oil well, for delivering nitrogen into the well. The use of nitrogen in a coiled tube helps to prevent corrosion in the tube.

### CROSS-REFERENCE TO RELATED APPLICATION

Priority is claimed from U.S. Provisional Patent Application Ser. No. 62/265,007,filed Dec. 9, 2015, the entire disclosure of which is hereby incorporated by reference.

### BACKGROUND OF THE INVENTION

The present invention relates to the making of high-purity nitrogen using non-cryogenic means, for inerting of coiled-tube systems, or other systems relating to oil and gas exploration.

It has been known to use a polymeric membrane to separate air into components. Various polymers have the property that they allow different gases to flow through, or permeate, the membrane, at different rates. A polymer used in air separation, for example, will pass oxygen and nitrogen at different rates. The gas that preferentially flows through the membrane wall is called the “permeate” gas, and the gas that tends not to flow through the membrane is called the “non-permeate” or “retentate” gas. The selectivity of the membrane is a measure of the degree to which the membrane allows one component, but not the other, to pass through.

A membrane-based gas separation system has the inherent advantage that the system does not require the transportation, storage, and handling of cryogenic liquids. Also, a membrane system requires relatively little energy. The membrane itself has no moving parts; the only moving part in the overall membrane system is usually the compressor which provides the gas to be fed to the membrane.

A gas separation membrane unit is typically provided in the form of a module containing a large number of small, hollow fibers made of the selected polymeric membrane material. The module is generally cylindrical, and terminates in a pair of tubesheets which anchor the hollow fibers. The tubesheets are impervious to gas. The fibers are mounted so as to extend through the tubesheets, so that gas flowing through the interior of the fibers (known in the art as the bore side) can effectively bypass the tubesheets. But gas flowing in the region external to the fibers (known as the shell side) cannot pass through the tubesheets.

In operation, a gas is introduced into a membrane module, the gas being directed to flow through the bore side of the fibers. One component of the gas permeates through the fiber walls, and emerges on the shell side of the fibers, while the other, non-permeate, component tends to flow straight through the bores of the fibers. The non-permeate component comprises a product stream that emerges from the bore sides of the fibers at the outlet end of the module.

Alternatively, the gas can be introduced from the shell side of the module. In this case, the permeate is withdrawn from the bore side, and the non-permeate is taken from the shell side.

An example of a membrane-based air separation system is given in U.S. Pat. No. 4,881,953, the disclosure of which is incorporated by reference herein.

Other examples of fiber membrane modules are given in U.S. Pat. Nos. 7,497,894, 7,517,388, 7,578,871 and 7,662,333, the disclosures of which are all hereby incorporated by reference.

Coiled metal tubes are typically inserted into oil wells, for the purpose of delivering drilling fluids, or inerting the contents of the wells, or for other purposes. After a coiled tube has been used in a particular well, it can be removed from the well, stored in a coiled state, such as on a reel, and used again at the same well or elsewhere.

A problem with the use of coiled tubes is their tendency to corrode. Inerting gases, typically high-purity nitrogen, have been used to provide an inert atmosphere for such tubes.

In the prior art, it was believed that a membrane-based system cannot be reliably used for making high-purity nitrogen for use in coiled-tubing applications.

The above opinion of the industry is based, in part, on the fact that it is difficult to predict module performance when producing high-purity nitrogen (99.9% or greater). The reason relates to inefficiencies in individual modules and with groupings of modules. These inefficiencies arise from flow distribution issues related to both individual modules and with parallel arrays of modules. There can be differences in module to module pressure drops, and feed/product manifold pressure drops. All of these inefficiencies become exaggerated when operating the module system to make high-purity nitrogen, in ways that are difficult to predict based on standard test data on individual modules.

The present invention resides in the discovery of a method of making nitrogen using a membrane-based system, which method yields nitrogen of very high purity, suitable for use with coiled-tube systems, and with other systems in which high-purity nitrogen is required.

### SUMMARY OF THE INVENTION

The present invention comprises a method and apparatus for generating high-purity nitrogen, and using said nitrogen in a coiled-tubing arrangement.

According to the present invention, the high-purity nitrogen is produced by passing a compressed stream of air into a membrane module, in which the permeate stream has a reduced oxygen content, and the retentate stream has an enriched oxygen content. The permeate stream is the product, and the retentate stream is waste, in this application. The permeate stream from the module is fed as the input stream to another, similar module.

In one embodiment, the output (permeate) of the second module comprises the product stream of high-purity nitrogen. In another, more preferred embodiment, a portion of the permeate stream is recycled to the inlet end of the compressor, thus joining the input ambient stream, and passing through the modules again. The result of this alternative is a nitrogen stream having even greater purity.

The high-purity nitrogen stream, produced as described above, is then fed into a coiled-tubing system, for inerting a well, or for other purposes.

The high-purity nitrogen stream can also be used in other applications related to the oil industry, including managed pressure drilling, well unloading, enhanced oil recovery, and gas lifting.

The invention therefore has the primary purpose of providing high-purity nitrogen, for use in a coiled-tubing system, or other system, at the site of an oil or gas well, by non-cryogenic means.

The invention has the further object of reducing corrosion in flexible metal tubing used in the oil or gas industry.

The invention has the further object of reducing corrosion in equipment used at the site of an oil or gas well.

The invention has the further object of avoiding the cost of providing high-purity nitrogen produced by cryogenic means.

The invention has the further object of enhancing the efficiency of oil or gas drilling, by reducing the cost of high-purity nitrogen used in such drilling.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a schematic diagram showing the system of the present invention.

FIG. 2 provides a perspective view of a coiled-tubing system, into which the output of the system of FIG. 1 is directed, according to the present invention.

### DETAILED DESCRIPTION OF THE INVENTION

The present invention comprises the use of membrane air separation technology in generating nitrogen of high purity, i.e. nitrogen in which there is about 0.1% residual oxygen, for use in oil or gas drilling and/or enhanced oil recovery, using coiled-tubing technology.

Coiled tubing technology comprises the use of coils of metal tubing to line wells while drilling or to pressurize existing drilled wells to promote oil production. Coiled tubing avoids the need to use fixed-length, straight tubing that is more cumbersome, and impossible to use for some directly drilled wells. Coiled tubing is particularly useful for angled drilling or directional drilling, where it is desired to provide a tube along a non-linear path. A coiled tube can be used to deliver gas to an existing well, and can later be retracted, stored on a reel, and used in the same well or in another well. The tube is typically formed of a flexible but strong metal, so the coiled tube can do essentially the same work as a conventional tube.

In applications in which coiled tubing is used, it is necessary to provide inert gases, having very low levels of oxygen, not only to avoid flammable conditions in the well, but to prevent rusting of the tubing. Avoidance of flammable conditions requires only that the oxygen content be in the range of about 3-7%, but avoidance of corrosion requires that the oxygen content be less than about 0.1%. Prevention of corrosion is important because it extends the useful life of the tubing.

To obtain high-purity nitrogen, having not more than 0.1% oxygen, the accepted practice of the industry is to produce nitrogen from air using conventional cryogenic separation techniques. Such nitrogen comes at a high cost, due both to the cost of the gas and the cost of transporting it to the oil field where it is needed.

Membrane processes typically produce enriched nitrogen by separating air, with a residual oxygen content of about 3-7%. In the present invention, however, the membrane system is operated to produce nitrogen having a purity of 99.9%, i.e. having only 0.1% oxygen, and in an economical manner.

The membrane system of the present invention is designed to operate in a series array, with a partial recycle loop, to minimize inefficiencies in the membrane processes that often prevent the membrane systems from producing the high-purity nitrogen in an economical way.

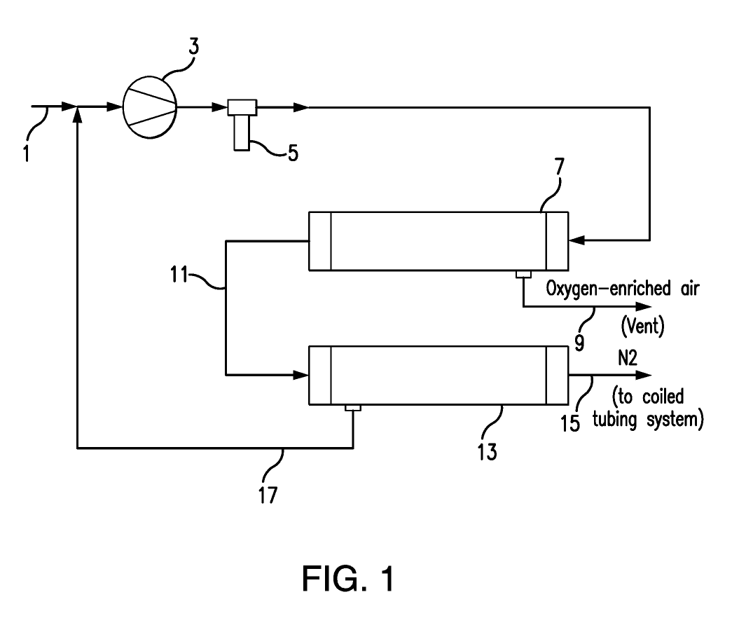

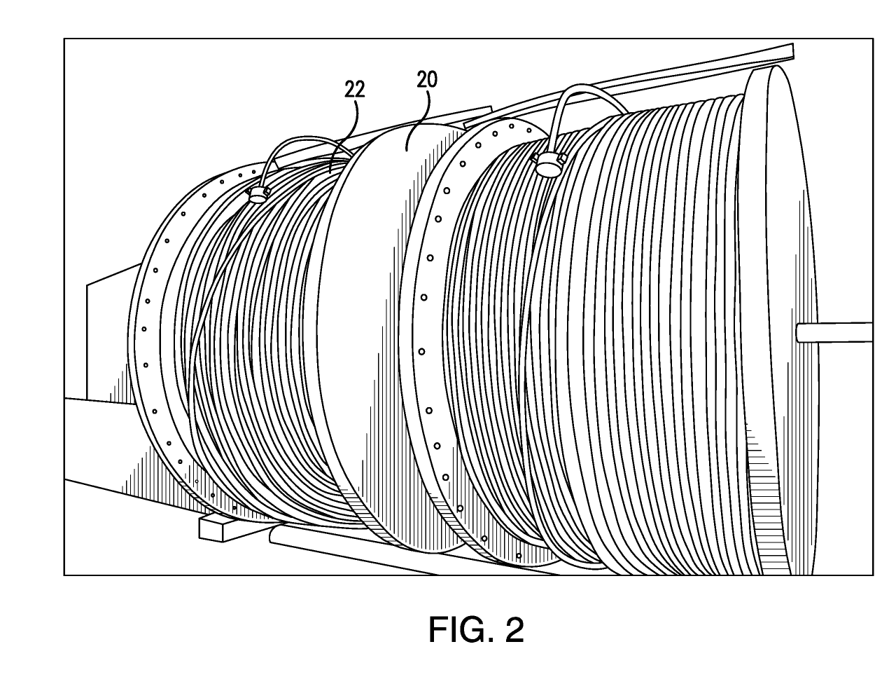

The present invention includes a method for making pure nitrogen, and a system for practicing that method. An example of the system is shown in FIGS. 1 and 2.

As shown in FIG. 1, ambient air enters the system through conduit 1, and is compressed in compressor 3. The compressed air may be filtered by passing it through filter 5. The compressed air then is directed through a gas-separation membrane module 7. The module includes a polymeric membrane material appropriate for separating air into its components. In the present example, the product gas is nitrogen, and the waste gas is oxygen. Oxygen-enriched air is therefore vented from the module through vent 9.

The product of module 7, which exits through conduit 11, comprises air in which the concentration of nitrogen is greater than ambient, and in which the concentration of oxygen is less than ambient. This stream then is the input to membrane module 13. The product of the module 13, appearing at outlet 15, is a stream of nitrogen having a high purity. The product of the module 13 comprises the output which is fed to a coiled-tubing system.

A portion of the stream being separated by module 13 may be conducted, by conduit 17, to the inlet of the compressor. This stream has a lower oxygen concentration than ambient, and using it as part of the inlet stream ultimately yields a product comprising nitrogen of very high purity. The recycling of the stream through conduit 17 is optional, however.

The output of the system shown in FIG. 1 is then conducted into a coiled-tube system, such as for inerting the contents of the coiled tube, or for other purposes associated with the operation of an oil well. A coiled-tube system is illustrated in FIG. 2, which shows tubing 22 wound around reels 20. The tubing can be readily unwound and fed into a well bore.

The advantage of the present invention is shown by the following Examples.

### EXAMPLE 1

This Example provides a baseline for evaluation of the present invention, and represents the prior art. In this Example, a plurality of membrane modules are arranged in parallel. A simple parallel array produces a product stream having a nitrogen purity of 99.9% (with 0.1% oxygen), at a rate of 11.3 scfm (standard cubic feet per minute) per membrane element. The membrane module used in this Example was a Model 7200 manufactured by Generon IGS, Inc. of Houston, Tex. The module has nominal dimensions of 10×72 inches. The module has a feed flow requirement of 190 psig compressed air at 45° C. and 85 scfm. This yields a product flow recovery of 13.3%. The recovery is defined as the ratio of product flow to feed flow.

The parallel arrangement of modules is the standard configuration for modules used in the oil and gas industry, for generating inert gas. The efficiency of the membrane system is low relative to ideal performance because of known variations in the modules that cause flow distribution issues when operated at product recoveries less than 30%. These flow distribution issues can greatly limit the operating efficiency of an individual module or groups of modules by not allowing for the uniform removal of oxygen from the feed stream in discrete parts of the module or systems of modules.

### EXAMPLE 2

In this Example, a system using Generon modules was constructed with the modules arranged in series. This arrangement also produces a product stream having a purity of 99.9% nitrogen, with 0.1% oxygen. In this arrangement, the modules are operated in series so the individual product recoveries for the individual stages are above 30%, and they do not suffer from the flow distribution inefficiencies seen in Example 1.

The two-module series array, using the same modules used in Example 1, produces high-purity nitrogen at 31 scfm (15.6 scfm per module) when operated at 190 psig and 45° C., while requiring 175 scfm of feed (87 scfm/module). In this case, the modules have a net product recovery of 17.8%. This represents a 38% increase in product flow and a 34% increase in product recovery as compared with Example 1.

### EXAMPLE 3

In this Example, a pair of modules were operated in series, with the addition of recycling part of the permeate stream from the second stage (module) to the inlet of the feed compressor. Thus, this Example uses the arrangement shown in the Figure.

The second stage permeate stream contains less than 7% oxygen and effectively lowers the oxygen level in the compressed feed stream to the first stage module(s) to around 17%.

Since there is less oxygen to remove, the operation is more efficient in producing the nitrogen of 99.9% purity. This type of operation, having two stages in series, with recycling of permeate, produces a product stream of 99.9% nitrogen (0.1% oxygen) at higher rates and efficiencies relative to Example 2.

In particular, with two modules connected in series, as shown in the Figure, the modules being the same as in Examples 1 and 2, the high-purity nitrogen stream is produced at 36 scfm (18 scfm per module) when operated at 190 psig and 45° C., while requiring 171 scfm of feed (86 scfm/module).

In this case, the modules have a net product recovery of 21.2%. This represents a 59% increase in product flow and in product recovery, as compared with Example 1. This translates directly to a lower cost for making high-purity nitrogen, in that both the capital cost (i.e. the number of modules) and the power cost (i.e. the amount of compressed feed air required) is only 62% of that needed for modules operated as in Example 1.

The above Examples show that with the improved performance achieved with the series arrangement used in Examples 2 and 3, it is economically feasible to provide high-purity nitrogen using a membrane-based system, for use with coiled tubing at the site of an oil well. The membrane-produced nitrogen is more advantageous than cryogenically-produced nitrogen, which would otherwise need to be transported to the well site in batches.

The use of membrane modules connected in parallel effectively provides a shorter path for gas. With membranes connected in series, there is a longer path, and a greater pressure drop. But this is not a major concern, because the pressure of the gas is often boosted before entry into the well, and most users of the gas will already have compressors available at the well site.

The series configuration, used in the present invention, allows each module to operate at higher recovery levels, where flow variability is less of a concern. The product gas is also allowed to mix between the two stages, even better to balance out the variable output from the individual fibers. Since the modules are in series and have higher pressure drops associated with them, problems with manifolding the feed and product flows are also minimized. The end result is that one can take quite dissimilar modules and get very reproducible performance when running them in series.

If a dedicated compressor is available, a series arrangement, with permeate recycling, as shown in the Figure, is the preferred choice for any purity level greater than 99%. Use of the arrangement of the present invention makes it practical to reduce the size of the compressor by 8-15%, and to reduce the module requirements by 5%.

The use of the series configuration, of the present invention, does have the disadvantage that, because the second stage permeate gas has less than 6% oxygen, it is not breathable. Such gas must be properly vented away or mixed with the permeate from the first stage to provide a breathable atmosphere. Therefore, the compressor used with this system must be dedicated to the membrane system, and must not be used inadvertently to provide compressed air for general purposes.

The present invention is not limited to use with coiled-tubing applications. Other applications, relating to the oil industry, which would benefit from the use of high-purity nitrogen produced by on-site membrane systems include managed pressure drilling, well unloading, enhanced oil recovery (EOR), and gas lifting. While some of these applications currently use nitrogen of only moderate purity, concerns about corrosion of process equipment will favor membrane systems that can produce nitrogen with lower oxygen content, just as has happened in the case of coiled-tubing technology.

The invention can be modified further, as will be appreciated by those skilled in the art. Such modifications should be considered to be within the spirit and scope of the following claims.

What is claimed is:

1. A method for providing nitrogen to a coiled-tubing system, the method comprising the steps of:
a) conveying air to a first module containing a polymeric membrane capable of separating air into its components, wherein an output of said first module comprises nitrogen-enriched air,
b) conveying the output of said first module into a second module containing a polymeric membrane capable of separating air into its components, wherein an output of said second module comprises substantially pure nitrogen, and
c) directing the output of said second module into a coiled tube.

2. The method of claim 1, further comprising directing at least a portion of gas flowing through said second module into said first module.

3. The method of claim 2, wherein step (a) is preceded by the step of compressing air in a compressor, and wherein said portion of gas flowing through said second module is directed into an input of said compressor.

4. The method of claim 1, wherein the method is performed in a vicinity of an oil well.

5. A method of providing nitrogen for a coiled-tubing system, the method comprising the steps of producing nitrogen, having a high purity, by passing air through a polymeric membrane module, the module being capable of separating air into its components, wherein an output of the module is a stream of high-purity nitrogen, the method further comprising the step of directing the high-purity nitrogen into a coiled tube.

6. The method of claim 5, further comprising inserting the coiled tube into an oil well for delivery of nitrogen into the well.

7. The method of claim 5, wherein the air-passing step comprises passing air through two polymeric membrane modules connected in series.

8. The method of claim 7, wherein there are first and second membrane modules, and wherein the method further comprises the step of recycling a portion of gas in said second membrane module into said first membrane module.

9. Apparatus for providing nitrogen to a coiled-tubing system, comprising a means for directing ambient air to a polymeric membrane module capable of separating air into its components, wherein a product of said membrane comprises nitrogen, and means for conveying said nitrogen into a coiled tube.

10. The apparatus of claim 9, wherein there are two membrane modules, connected in series.

11. The apparatus of claim 9, further comprising a compressor, connected to receive the ambient air, an output of the compressor being connected to an input of the membrane module.

12. The apparatus of claim 10, further comprising a conduit for conveying a portion of air flowing through a second of said two membrane modules into said compressor.
